(19) United States
(12) Patent Application Publication
(10) Pub. No.: US 2022/0363967 A1
(43) Pub. Date: Nov. 17, 2022

(54) Refrigerant Comprising Methane, And Refrigeration System And Cabinet With Such Refrigerant

(71) Applicant: ARCTIKO A/S, Esbjerg N (DK)

(72) Inventors: Tove TÆKKER SVENDSEN, Esbjerg N (DK); Hans Jørgen NIELSEN, Esbjerg N (DK); Asbjørn Leth VONSILD, Vejle (DK)

(73) Assignee: ARCTIKO A/S, Esbjerg N (DK)

(21) Appl. No.: 17/767,183

(22) PCT Filed: Oct. 7, 2020
(86) PCT No.: PCT/DK2020/050273

§ 371 Date: Apr. 7, 2022

(30) Foreign Application Priority Data
Oct. 7, 2019 (DK) PCT/DK2019/050296

(51) Int. Cl. C09K 5/04; F25B 9/00; F25B 40/02

(52) U.S. Cl. CPC C09K 5/042; F25B 9/006; F25B 40/02; C09K 2205/12; F25B 2400/12

(57) ABSTRACT

The invention relates to a refrigerant for use in a single-stage or auto cascade refrigeration system. The refrigerant comprises a mixture of gasses of at least three different hydrocarbons. The at least three different hydrocarbons include butane (C4H10), ethene (C2H4) and methane (CH4). The mixture of gasses comprises at the most 10% by weight of methane (CH4). The invention also relates to a refrigeration system with methane-containing refrigerant, to a refrigeration cabinet with methane-containing refrigerant and to use of a refrigeration cabinet with such refrigerant.

### TECHNICAL FIELD

The present invention relates to refrigerant and to a single-stage or auto cascade refrigeration system comprising at least one set of refrigeration components including a compressor, at least one condenser, at least a first heat exchanger, at least one flow restriction and at least one evaporator, and which refrigeration system comprises a refrigerant. The present invention furthermore relates to a refrigeration cabinet with a refrigeration system and to use of a refrigeration cabinet for cooling of goods.

### BACKGROUND OF INVENTION

It is the object of the invention to obtain an environmentally friendly low temperature refrigerant and refrigeration system. It is a further object of the invention to obtain a mixture of refrigerants for refrigeration systems, where all the refrigerants contained in the mixture are environmentally friendly. A further object of the pending application is the use of a limited amount of environmentally friendly mixture of refrigerants.

JP 2009 102567 discloses a refrigerant mixture of gasses comprising butane, ethene and methane. JP 2009 102567 discloses butane in an amount of between 60% and 90% of the total amount of mixtures of gasses, ethene in an amount of between 10% and 30% of the total amount of mixtures of gasses, and methane in an amount of between 1% and 20% of the total amount of mixtures of gasses. No other amounts are disclosed.

JP 2009 102567 does not disclose any other intervals than the very broad intervals mentioned above, and within which very broad intervals of amount of refrigerants, the amount of the different refrigerants will not suit specific purposes for refrigeration. No specific components of a refrigeration system or of a refrigeration cabinet are disclosed.

JP 2009 102567 does not disclose any use of the mixture of gasses, neither in relation to the volume of a refrigeration cabinet to be refrigerated, neither in relation to the temperature to be reached during refrigeration, nor in relation to the type and configuration of refrigeration system in which the mixture of gasses is to be used. WO 2011/150940 discloses a refrigerant mixture of gasses comprising butane, isobutane, ethene and methane. The amount of the different gasses in the mixture of gasses are disclosed as butane in an amount of between 40% and 60% of the total amount of mixtures of gasses, isobutane in an amount of between 5% and 15% of the total amount of mixtures of gasses, ethene in an amount of between 15% and 35% of the total amount of mixtures of gasses, and methane in an amount of between 1% and 10% of the total amount of mixtures of gasses. WO 2011/150940 does not disclose any other intervals than the very broad intervals, and within which very broad intervals, the amount of the different refrigerants will not suit specific purposes for refrigeration.

### SUMMARY OF INVENTION

The object may be achieved by a refrigerant comprising a mixture of gasses of at least three different hydrocarbons, wherein the at least three different hydrocarbons include butane (C4H10,R600), ethene (C2H4,R1150) and methane (CH4,R50), and wherein the mixture of gasses comprises at the most 10% by weight of methane (CH4,R50).

The mixture of gasses may possibly comprise a hydrocarbon additional to the at least three hydrocarbons named above, namely the additional hydrocarbon of isobutane (R600a), but only in a very limited amount of approximately 10 weight percent.

Isobutane (R600a) in a weight percent above that amount will render the gas mixture less suitable for an intended use of cooling between −40 and −90 degrees Celsius.

The weight percent of methane (R50) must also be limited for the intended use in order to keep pressure on the high-pressure side of the refrigeration system at a suitable level.

The object of the invention may also be achieved by a refrigeration cabinet comprising mixture of gasses of at least three different hydrocarbons, including butane (C4H10,R600), ethene (C2H4, R1150)) and methane (CH4, R50), wherein the mixture of gas comprises at the most 10% by weight of methane (CH4, R50).

The mixture of gasses may advantageously comprise a hydrocarbon additional to the at least three hydrocarbons of butane, ethene and methane, namely the hydrocarbon of isobutane (C4H10, R600a), but only in a very limited amount of between 10% and 30% by weight of the mixture of gasses, preferably less than 15% by weight of the mixture of gasses, most preferred approximately 10% by weight of the mixture of gasses.

The amounts of butane (C4H10,R600) and ethene (C2H4,R1150) are preferably between 50% and 74% by weight of butane (C4H10,R500) between 25% and 40% by weight of ethene (C2H4,R1150).

Isobutane (C4H10,R600a) in a weight percent above that amount may render the gas mixture unusable for an intended use of cooling between −40 and −90 degrees Celsius.

The weight percent of methane (CH4,R50) must also be limited for the intended use in order to keep the pressure on the high-pressure side of the refrigeration system at a low level.

Preferably, according to the intended sue of cooling to a temperature between −40 and −90 degrees Celsius, at least one of the evaporators for cooling of goods, preferably a plurality of the evaporators for cooling of goods, possibly all of the evaporators for cooling of goods, are placed in shelves inside an interior of the refrigeration cabinet, which shelves are for supporting goods to be cooled in the refrigeration cabinet.

The mixture of refrigerant gasses is an environmentally so-called green mixture of gasses, because all gasses contained are environmentally friendly. With the mixture as described, it is possible to achieve a low temperature refrigeration system. A refrigeration system containing only so-called green refrigeration components can be used even if a leak occurs in the refrigeration system and the refrigerant is leaking into the surroundings. In use of a refrigeration system, it is much easier to exchange the refrigerant gasses, if at least smaller amounts of the refrigerant are allowed to leak from the refrigeration system.

The refrigeration system may comprise at least one compressor, which compressor has a pressure outlet connected to a condenser, from which condenser the high pressure refrigerant flows through a heat exchanger, in which heat exchanger the high pressure refrigerant is cooled by low pressure cold refrigerant flowing back towards the suction inlet at the compressor, from which heat exchanger the high pressure refrigerant flows towards a flow restriction in form of a capillary tube, from which capillary tube the low pressure refrigerant flows through an evaporator, from which evaporator the low pressure refrigerant flows back through the heat exchanger to the suction inlet of the compressor. Hereby a highly effective refrigeration system may be achieved that can be used e.g. in ultra low temperature freezers.

Another possibility for a refrigeration system is to use the system in portable freezers in a temperature area of −80° C. The refrigeration system may be used in upright low and ultra low temperature freezers. Further, it is possible to use the refrigeration system in ultra low temperature chest freezers, may be used for laboratory or pharmaceutical refrigerators and freezers. Another possibility is to form a cold store room with the refrigeration system. This could e.g. be made in a container. In this way, it should be able to achieve a highly effective container refrigeration system in which container refrigeration system it is possible to achieve extremely low temperatures such as temperatures ranging in the area −40 to −90 degrees Celsius, possibly −60 degrees Celsius to −80 degrees Celsius.

The refrigeration system may be a single-stage compressor system especially designed for ultra low temperature purposes. The compressor may have a limited pressure capacity of 4 MPa at the most. It is possible with the single-stage compressor to obtain low energy consumption, low noise, and low heat dissipation. The refrigeration system achieves a temperature as low as −85 degrees Celsius and has small dimensions, ensuring easy access to all the different storage rooms that must be accessed from the front of a refrigeration system.

In a possible embodiment, the condenser can be coil-shaped, but many different condensers may be used instead. Using a coil-shaped condenser avoids building up dust at the condenser and therefore no need for cleaning of the condenser unit as such. Even after years of operation, the coil formed condenser will still be highly effective. This is highly effective compared to traditional condenser units that are partly closed because of having a large surface for conducting most of the heat to the surrounding air.

The refrigerant constituted by the mixture of gasses may be used in many different refrigeration systems such as low temperature refrigeration rooms for storage of medicine or other chemical substances typical in the temperature range from −40° C. to −60° C. Another possibility is to use the new mixture of refrigerants in mobile applications such as mobile containers for achieving temperatures at −60 degrees Celsius in the application. Further, the mixture of gasses may be used in all low temperature freezers.

According to a preferred composition of the refrigerant, the mixture of gasses comprises between 50% and 74% by weight of butane (C4H10,R600).

According to the preferred composition of the refrigerant, the mixture of gasses comprises between 25% and 40% by weight of ethene (C2H4,R1150).

According to a refrigeration system of the invention, the refrigeration system is a single-stage or auto cascade refrigeration system comprising at least one compressor, at least one condenser, at least a first heat exchanger, at least one flow restriction, at least one evaporator, all refrigeration components being interconnected serially in a refrigerant circuit, and which refrigeration system comprises a mixture of gasses of at least three different hydrocarbons, including butane (C4H10;R600), ethene (C2H4,R1150) and methane (CH4,R50), wherein the mixture of gas comprises at the most 10% by weight of methane (CH4,R50).

According to a possible embodiment of the refrigeration system of the invention, the mixture of gas comprises between 1% and 6% by weight of methane (CH4,R50).

According to a possible embodiment of the refrigeration system of the invention, the mixture of gas comprises between 1% and 4% by weight of methane (CH4,R50).

According to a possible embodiment of the refrigeration system of the invention, the mixture of gas comprises between 1.5% and 4% by weight of methane (CH4,R50).

According to one possible embodiment of a refrigeration cabinet of the invention, the refrigeration cabinet has an interior volume of between 400 and 500 litres, with a cooling capacity of between −40 and −90 degrees Celsius, and wherein the total weight of mixture of gasses in at least one refrigeration circuit of the refrigeration cabinet is at the most 150 grams.

According to another possible embodiment of the refrigeration cabinet of the invention, the refrigeration cabinet has an interior volume of between 500 and 600 litres, with a cooling capacity of between −40 and −90 degrees Celsius, and wherein the total weight of mixture of gasses in at least one refrigeration circuit of the refrigeration cabinet is at the most 200 grams.

According to yet another possible embodiment of the refrigeration cabinet of the invention, the refrigeration cabinet has an interior volume of between 600 and 700 litres, with a cooling capacity of between −40 and −90 degrees Celsius, and wherein the total weight of mixture of gasses in at least one refrigeration circuit of the refrigeration cabinet is at the most 250 grams.

According to still another possible embodiment of the refrigeration cabinet of the invention, the refrigeration cabinet has an interior volume of between 700 and 800 litres, possible between 700 and 1000 litres, with a cooling capacity of between −40 and −90 degrees Celsius, and wherein the total weight of mixture of gasses in at least one refrigeration circuit of the refrigeration cabinet is at the most 300 grams, possibly at the most 500 grams.

According to a preferred embodiment of the refrigeration system of the invention, the refrigeration system comprises an intermediate heat exchanger, which internal heat exchanger (IHX) is for evaporating at least part of the butane (C4H10,R600) and for condensing at least part of the ethene (C2H4,R1150) and/or methane (CH4,R50), and placed between a condenser and a non-internal heat exchanger for goods to be cooled.

An internal heat exchanger (IHX) is used for transferring heat between a low side pressure refrigerant circuit and a high side pressure refrigerant circuit. The function of the internal heat exchanger (IHX) is to improve system performance by further sub-cooling a refrigerant being supplied to an evaporator.

According to a possible embodiment of the refrigeration system of the invention, the refrigeration system comprises a first refrigeration circuit being a single-stage or auto cascade refrigeration system comprising of first refrigeration components being at least one first compressor, at least one first condenser, at least a first heat exchanger, at least one first flow restriction and at least one first evaporator, all first refrigeration components being interconnected serially in a first refrigerant circuit, and a second refrigeration circuit being a single-stage or auto cascade refrigeration system comprising at least one second compressor, at least one second condenser, at least one second heat exchanger, at least one second flow restriction and at least one second evaporator, all second refrigeration components being interconnected serially in a second refrigerant circuit, which second refrigeration circuit is separate from the first refrigeration circuit, and which at least the first set of refrigeration components also comprises at least one first internal heat exchanger (IHX) for evaporating at least part of the butane (C4H10,R600) and for condensing at least part of the ethene (C2H4,R1150) and/or methane (CH4,R50), and placed between a condenser and a non-internal heat exchanger for goods to be cooled.

According to possible embodiments of a refrigeration cabinet of the invention, the total weight of mixture of gasses in the first refrigeration circuit is at the most 150 grams, and where the total weight of mixture of gasses in the second refrigeration circuit is at the most 150 grams, if the volume to be refrigerated is between 300 and 400 litres, or the total weight of mixture of gasses in the first refrigeration circuit is at the most 200 grams, and where the total weight of mixture of gasses in the second refrigeration circuit is at the most 200 grams, if the volume to be refrigerated is between 400 and 500 litres, the total weight of mixture of gasses in the first refrigeration circuit is at the most 250 grams, and where the total weight of mixture of gasses in the second refrigeration circuit is at the most 150 grams, if the volume to be refrigerated is between 500 and 700 litres, the total weight of mixture of gasses in the first refrigeration circuit is at the most 500 grams, and where the total weight of mixture of gasses in the second refrigeration circuit is at the most 500 grams, if the volume to be refrigerated is between 700 and 900 litres, possibly as much as 1000 litres.

The mixture of environmentally friendly gasses may be used in refrigeration cabinets with refrigeration systems for achieving storage temperature below −40 degrees Celsius, preferably below −60 degrees Celsius, possibly as low as −90 degrees Celsius.

### BRIEF DESCRIPTION OF DRAWINGS

FIG. 1 shows one embodiment of a refrigeration system according to the invention,

FIG. 2 shows another embodiment of a refrigeration system according to the invention,

FIG. 3 shows a more detailed view of the refrigeration system shown in FIG. 2.

FIG. 4 shows a refrigeration system comprising two refrigeration circuits.

### DETAILED DESCRIPTION OF INVENTION

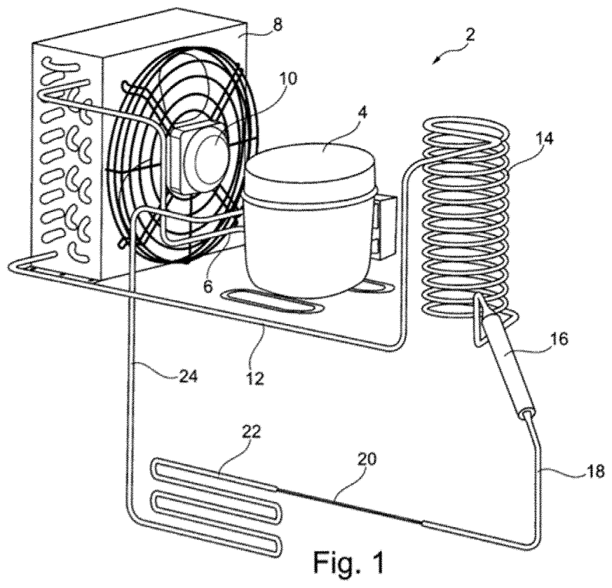

FIG. 1 shows a refrigeration system 2 which system comprises a compressor 4, which compressor has a pressure outlet connected to a tube 6, which tube 6 is connected to a condenser unit 8 which can be cooled by means of a blowing unit 10 and from which condensing unit a tube 12 leads high pressure refrigerant further to a coil 14. From the coil 14 where further condensing takes place, the refrigerant is flowing further into a receiver 16. Here from the refrigerant flows through a tube 18 towards a capillary tube 20 and further into an evaporator 22. The low pressure refrigerant from the evaporator is flowing back through a tube 24 to the inlet of the compressor 4.

Using the new mixture of refrigerants, it is possible by the refrigeration system 2 shown at FIG. 1 to achieve very low temperatures even by a single-stage or auto cascade refrigeration system. The different gasses evaporate at different temperatures. By mixing gasses with sufficient low boiling points with normal boiling points, it is possible to adjust the refrigerant constituted by the mixture of gasses more or less to a specific temperature. A highly effective refrigeration system for low temperature purposes can be achieved. This can lead to a very effective reduction in power consumption, even when reaching temperatures below −60° C.

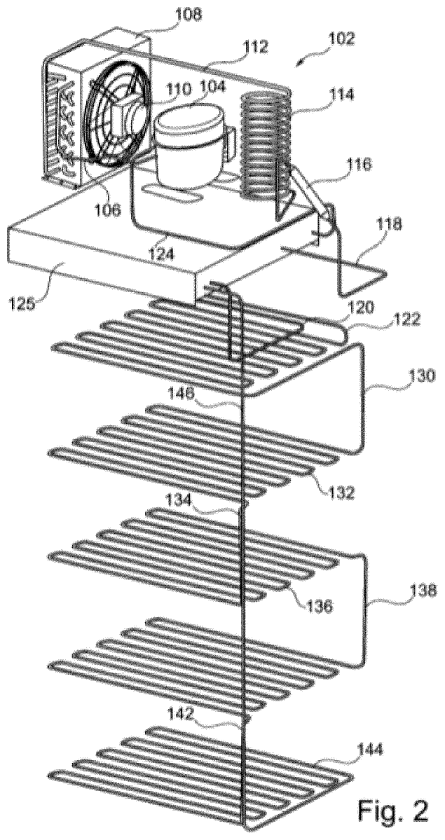

FIG. 2 shows a refrigeration system for an ultra low temperature freezer. The refrigeration system 102 comprises a compressor 104. The compressor 104 has an outlet tube 106 connected through a condenser 108. The condenser is cooled by heat dissipating means such as a fan 110. From the condenser 108, a tube 112 leads to a coil 114. From the coil, the refrigerant is passed into a receiver 116. From the receiver 116, a tube 118 leads to an internal heat exchanger (IHX) 125.

The gas from the tube 118 exits the internal heat exchanger 125 through a tube 120. The tube 120 is connected to a capillary tube (not shown). From the capillary tube, a tube 122 leads to the first evaporator 122. A tube 130 leads to the next evaporator 132. From the evaporator 132, a tube 134 leads to an evaporator 136. From the evaporator 136, a tube 138 leads to a further evaporator 140. From the further evaporator, a tube 142 leads to the final evaporator 144. From the final evaporator 144, a return tube 146 leads to the internal heat exchanger (IHX) 125, from which internal heat exchanger 125, the return line continues along the tube 124 towards the suction inlet at the compressor 104. The internal heat exchanger 125 has a low-pressure side, where at least part of the butane is evaporated, and the internal heat exchanger 125 has a high-pressure side, where at least part of the ethene and/or methane is condensed.

Using the new mixture of gasses in a refrigeration system as shown in FIG. 2, temperatures as low as below −80 degrees Celsius may be obtained in an ultra low temperature freezer, and temperatures as low as −80 degrees Celsius can be obtained by a single compressor with very low power consumption. The low power consumption leads to low heat dissipation.

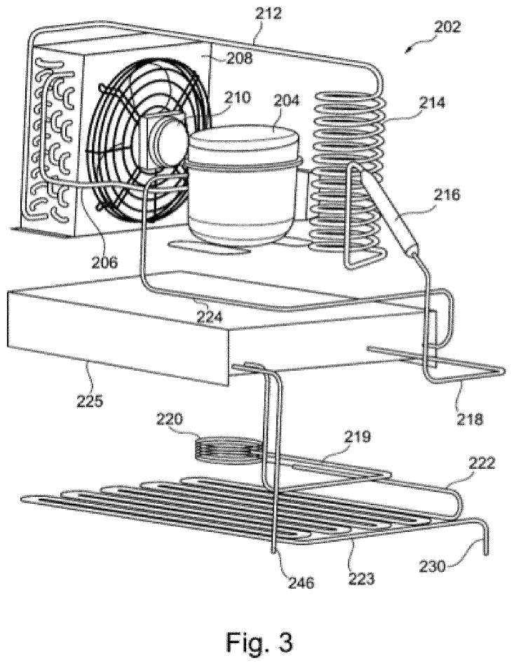

FIG. 3 shows an enlarged view of the upper part of FIG. 2. FIG. 3 shows a refrigeration system 202 comprising a compressor 204. The compressor 204 has an outlet 206 connected through a condenser 208, which is cooled by heat dissipating means 210 such as a fan. A tube 212 leads to a coil 214 for further condensation, from where the refrigerant is passed to a receiver 216. From the receiver, a tube 218 leads to an internal heat exchanger (IHX) 225. The internal heat exchanger (IHX) 225 has a low-pressure side where at least part of the butane is evaporated, and the internal heat exchanger 225 has a high-pressure side where at least part of the ethene and/or methane is condensed.

If the refrigeration system is part of a refrigeration cabinet, the internal heat exchanger 125,225 is preferably placed within insulation of the refrigeration cabinet. Thereby, the internal heat exchanger 125,225 is insulated from the surroundings, so that heat dissipation from the surroundings to the internal heat exchanger 125,225 is minimized.

The refrigerant leaves the internal heat exchanger (IHX) 225 through a tube 219 that leads to a flow restriction formed as a capillary tube 220 from which capillary tube the refrigerant flows through a tube 222 towards an evaporator 223. The refrigerant leaves the evaporator 223 through a tube 230 to further evaporators (not shown). The refrigerant returns from the evaporators through a tube 246 which is sent to the internal heat exchanger (IHX) 225. The refrigerant leaves the internal heat exchanger (IHX) 225 through a tube 224 that leads to the inlet of the compressor 204.

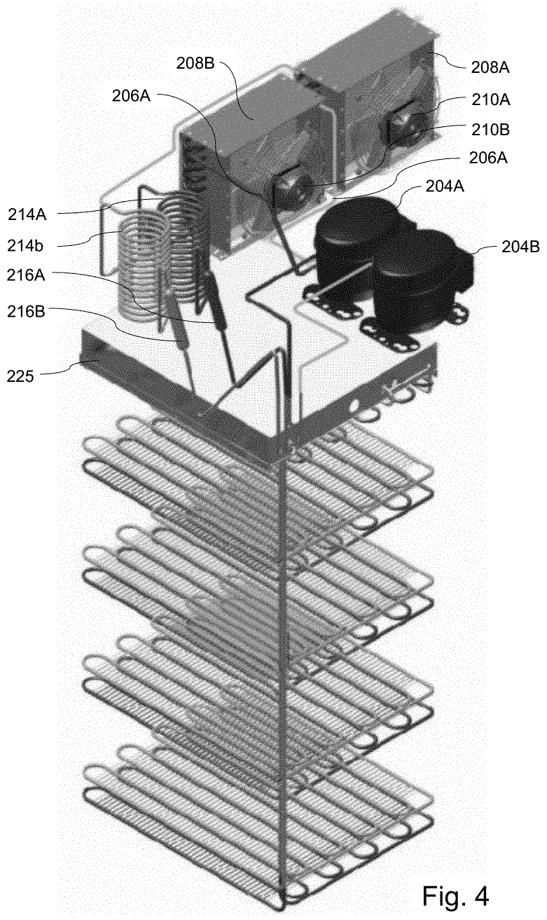

FIG. 4 shows a refrigeration system 2, which system comprises two refrigeration circuits. The two refrigeration circuits are separate from each other. Each of the two refrigeration circuits has a compressor 4, which compressor has a pressure outlet connected to a tube 6, which tube 6 is connected to a condenser unit 8 which can be cooled by means of a blowing unit 10 and from which condensing unit a tube 12 leads high pressure refrigerant further to a coil 14.

A first refrigeration circuit comprises a set of first evaporators and a second refrigeration circuit comprises a set of second evaporators. The first set of evaporators and the second set of evaporators are intended for being part of shelves in a refrigeration cabinet, the shelves made for supporting goods to be cooled in the refrigeration cabinet.

The first refrigeration circuit is arranged for obtaining a first refrigeration temperature and the second refrigeration circuit is arranged for obtaining a second refrigeration temperature, lower than the first refrigeration temperature. Also, the second refrigeration circuit may function as a back up refrigeration circuit to the first refrigeration circuit, if the first refrigeration circuit fails, and vice versa.

As example, a refrigerator of an interior capacity of 390 litres with a cooling temperature range between −40 and −90 degrees Celsius, the refrigerator has a dual circuit refrigeration system as shown in FIG. 4 and with a very limited amount of refrigerant, less than 150 g. Furthermore, the gas mixture comprises a very limited amount of isobutane (R600) and a very limited amount of methane (R50), only 2.0 weight percent of the total weight of gas mixture.

As example, a refrigerator of an interior capacity of 500 litres with a cooling temperature range between −40 and −90 degrees Celsius, the refrigerator has a dual circuit refrigeration system as shown in FIG. 4 and with a very limited amount of refrigerant, less than 200 g., only 190 g. Furthermore, the gas mixture comprises a very limited amount of methane (R50), only 2.1 weight percent of the total weight of gas mixture.

As example, a refrigerator of an interior capacity of 610 litres with a cooling temperature range between −40 and −90 degrees Celsius, the refrigerator has a dual circuit refrigeration system as shown in FIG. 4 and with a very limited amount of refrigerant, less than 250 g, only 200 g. Furthermore, the gas mixture comprises a very limited amount of methane (R50), only 2.8 weight percent of the total weight of gas mixture.

As example, a refrigerator of an interior capacity of 820 litres with a cooling temperature range between −40 and −90 degrees Celsius. The refrigerator has a dual circuit refrigeration system as shown in FIG. 4 and with a very limited amount of refrigerant, less than 300 g., only 270 g. Furthermore, the gas mixture comprises a very limited amount of methane (R50), only 2.2 weight percent of the total weight of gas mixture.

1. A refrigerant for use in a single-stage or auto cascade refrigeration system, the refrigerant comprising a mixture of gasses of at least three different hydrocarbons, wherein the at least three different hydrocarbons include butane (5 C4H10,R600), ethene (C2H4,R1150) and methane (CH4,R50), and wherein the mixture of gasses comprises between 1% and 6% by weight of methane (CH4,R50) of a total weight of the mixture of gasses.

2. A refrigerant according to claim 1, wherein the mixture of gasses comprises between 50% and 74% by weight of butane (C4H10,R600) of the total weight of the mixture of gasses.

3. The refrigerant according to claim 1, wherein the mixture of gasses comprises between 25% and 40% by weight of ethene (C2H4,R1150) of the total weight of the mixture of gasses.

4. The refrigerant according to claim 1, wherein the mixture of gasses comprises between 10% and 30% by weight of isobutane (C4H10,R600a) of the total weight of the mixture of gasses.

5. A refrigeration system comprising at least one compressor, at least one condenser, at least a first heat exchanger, at least one flow restriction, at least one evaporator all refrigeration components being interconnected serially in a refrigerant circuit, and which refrigeration system comprises mixture of gasses of at least three different hydrocarbons, including butane (C4H10,R600), ethene (C2H4,R1150) and methane (CH4,R50), wherein the mixture of gas comprises at the most 10% by weight of methane (CH4,R50) of a total weight of the mixture of gasses.

6. The refrigeration system according to claim 5, which refrigeration system is a single-stage or auto cascade refrigeration system, and wherein the mixture of gas comprises between 1% and 6% by weight of methane (CH4,R50) of the total weight of the mixture of gasses.

7. The refrigeration system according to claim 6, which refrigeration system is a single-stage or auto cascade refrigeration system, and wherein the mixture of gas comprises between 2% and 4% by weight of methane (CH4,R50) of the total weight of the mixture of gasses.

8. The refrigeration system according to claim 5, which refrigeration system is a single-stage or auto cascade refrigeration system, wherein the refrigeration 5 system is capable of refrigerating goods to a temperature between −40 and −90 degrees Celsius, and wherein the total weight of the mixture of gasses in the refrigeration circuit is at the most 150 grams.

9. The refrigeration system according to claim 5, wherein the refrigeration system is capable of refrigerating goods to a temperature between −40 and −90 degrees Celsius, and wherein the total weight of the mixture of gasses in the refrigeration circuit is at the most 200 grams.

10. The refrigeration system according to claim 5, wherein the refrigeration system is capable of refrigerating goods to a temperature between −40 and −90 degrees Celsius, and wherein the total weight of the mixture of gasses in the refrigeration circuit is at the most 250 grams.

11. The refrigeration system according to claim 5, wherein the refrigeration system is capable of refrigerating goods to a temperature between −40 and −90 degrees Celsius, and wherein the total weight of the mixture of gasses in the refrigeration circuit is at the most 300 grams, possibly at the most 500 grams.

12. The refrigeration system according to claim 5, which refrigeration system is a single-stage or auto cascade refrigeration system comprising an internal heat exchanger, which internal heat exchanger (IHX) is for evaporating at least part of the butane (C4H10,R600) and for condensing at least part of the ethene (C2H4,R1150) and/or methane (CH4,R50), and placed between a condenser and a non-internal heat exchanger (IHX) for goods to be cooled.

13. The refrigeration system according to claim 5, which refrigeration system comprises—a first single-stage or auto cascade refrigeration circuit with a set of first refrigeration components being at least one first compressor, at least one first condenser, at least a first heat exchanger, at least one first flow restriction and at least one first evaporator, all first refrigeration components being interconnected serially in a first refrigerant circuit, and—a second single-stage or auto cascade refrigeration circuit with a second set of at least one second compressor, at least one second condenser, at least one second heat exchanger, at least one second flow restriction and at least one second evaporator, all second refrigeration components being interconnected serially in a second refrigerant circuit, which second refrigeration circuit is separate from the first refrigeration circuit, and-which refrigeration components also comprises at least one first internal heat exchanger (IHX) is provided for evaporating at least part of the butane (C4H10,R600) and for condensing at least part of the ethene (C2H4,R1150) and/or for condensing at least part of the methane (CH4, R50), and where the at least one first internal heat exchanger (IHX) is placed between a condenser and a non-internal heat exchanger for goods to be cooled.

14. The refrigeration system according to claim 13, if isobutane (C4H10,R600a) is present in the refrigeration system, the at least one first internal heat exchanger (IHX) is provided for possibly evaporating at least part of the isobutane (C4H10,R600a).

15. A refrigeration cabinet for cooling of goods, the refrigeration apparatus comprising a single-stage or auto cascade refrigeration system comprising
at least one compressor, at least one condenser, at least a first heat exchanger, at least one flow restriction and at least one evaporator, all refrigeration components being interconnected serially in a refrigerant circuit, and which refrigeration cabinet comprises mixture of gasses of at least three different hydrocarbons, including butane (C4H10,R600), ethene (C2H4,R1150) and methane (CH4,R50), wherein the mixture of gas comprises at the most 10% by weight of methane (CH4,R50) of the total weight of the mixture of gasses, and where at least one of the evaporators for cooling of goods, preferably a plurality of the evaporators for cooling of goods, possibly all of the evaporators for cooling of goods, are placed in shelves inside an interior of a chamber of the refrigeration cabinet, which shelves are for supporting goods to be cooled in the refrigeration cabinet.

16. The refrigeration cabinet according to claim 15, wherein the refrigeration cabinet has an interior volume of between 400 and 500 litres, with a cooling capacity of between −40 and −90 degrees Celsius, and wherein a total weight of mixture of gasses in at least one refrigeration circuit of the refrigeration cabinet is at the 5 most 150 grams.

17. The refrigeration cabinet according to claim 15, wherein the refrigeration cabinet has an interior volume of between 500 and 600 litres, with a cooling capacity of between −40 and −90 degrees Celsius, and wherein a total weight of mixture of gasses in at least one refrigeration circuit of the refrigeration cabinet is at the most 200 grams.

18. The refrigeration cabinet according to claim 15, wherein the refrigeration cabinet has an interior volume of between 600 and 700 litres, with a cooling capacity of between −40 and −90 degrees Celsius, and wherein a total weight of mixture of gasses in at least one refrigeration circuit of the refrigeration cabinet is at the most 250 grams.

19. The refrigeration cabinet according to claim 15, wherein the refrigeration cabinet has an interior volume of between 700 and 900 litres, possible between 700 and 1000 litres, with a cooling capacity of between −40 and −90 degrees Celsius, and wherein a total weight of mixture of gasses in at least one refrigeration circuit of the refrigeration cabinet is at the most 300 grams, possibly at the most 500 grams.

20. The refrigeration cabinet according to claim 15, which refrigeration cabinet comprises-a first set of first refrigeration components being at least one first compressor, at least one first condenser, at least a first heat exchanger, at least one first flow restriction and at least one first evaporator, all first refrigeration components being interconnected serially in a first refrigerant circuit, and-a second set of at least one second compressor, at least one second condenser, at least one second heat exchanger, at least one second flow restriction and at least one second evaporator, all second refrigeration components being interconnected serially in a second refrigerant circuit, which second refrigeration circuit is separate from the first refrigeration circuit, and—where at least the first set of refrigeration components also comprises at least one internal heat exchanger (IHX) for evaporating at least part of the butane (C4H10,R600) and for condensing at least part of the ethene (C2H4,R1150) and/or methane (CH4,R50), and placed between a condenser and a non-internal heat exchanger for goods to be cooled.

21. The refrigeration cabinet according to claim 20, where a total weight of mixture of gasses in the first refrigeration circuit is at the most 150 grams, 5 and where a total weight of mixture of gasses in the second refrigeration circuit is at the most 150 grams.

22. The refrigeration cabinet according to claim 20, where a total weight of mixture of gasses in the first refrigeration circuit is at the most 200 grams, and where a total weight of mixture of gasses in the second refrigeration circuit is at the most 200 grams.

23. The refrigeration cabinet according to claim 20, where a total weight of mixture of gasses in the first refrigeration circuit is at the most 250 grams, and where a total weight of mixture of gasses in the second refrigeration circuit is at the most 250 grams.

24. The refrigeration cabinet according to claim 20, where a total weight of mixture of gasses in the first refrigeration circuit is at the most 300 grams, and where a total weight of mixture of gasses in the second refrigeration circuit is at the most 300 grams.

25. The refriaeration cabinet according to claim 15, where at least one of the evaporators for cooling of goods is placed in a top of the interior of a chamber of the refrigeration cabinet.

26. The refrigeration cabinet according to claim 15, which refrigeration cabinet comprises at least one internal heat exchanger (IHX) for evaporating at least part of the butane (C4H10, R600) and for condensing at least part of the ethene (C2H4,R1150) and/or methane (CH4,R50).

27. The use of a refrigeration cabinet according to claim 15 for cooling of goods to a temperature between −40 and −90 degrees Celsius.
